(19) United States
(12) Patent Application Publication
(10) Pub. No.: US 2020/0027084 A1
(43) Pub. Date: Jan. 23, 2020

(54) Method and System for Hybrid Payment Authorization

(71) Applicant: MASTERCARD INTERNATIONAL INCORPORATED, Purchase, NY (US)

(72) Inventors: Peter Groarke, Dublin (IE); Ahmed Hosny, Dublin (IE)

(73) Assignee: MASTERCARD INTERNATIONAL INCORPORATED, Purchase, NY (US)

(21) Appl. No.: 16/042,298

(22) Filed: Jul. 23, 2018

(51) Int. Cl. G06Q 20/40; H04L 9/30; H04L 9/06; H04L 9/32

(52) U.S. Cl. CPC G06Q 20/401; H04L 9/30; G06Q 2220/00; H04L 9/3247; H04L 9/0637

(57) ABSTRACT

A method for hybrid payment authorization includes: storing a merchant profile including a merchant identifier and a merchant public key; receiving an authorization request for a payment transaction including an account number from an external entity, the merchant identifier, and a transaction amount; generating a recipient blockchain address using the merchant public key; transmitting the recipient blockchain address, a blockchain amount based on the transaction amount, and a sender digital signature to a node in a blockchain network; generating an authorization response for the payment transaction including a response code indicating approval or denial of the payment transaction; and transmitting the generated authorization response to the external entity.

### FIELD

The present disclosure relates to hybrid payment authorizations, specifically the use of a traditional transaction messaging infrastructure for conveyance of a payment authorization request, where the authorization can be for a transaction funded using fiat currency or a blockchain currency depending on the receiving merchant using a single account number.

### BACKGROUND

With the increase in popularity and value, many consumers are interested in using blockchain currencies to fund electronic payment transactions. Blockchain currencies provide consumers with a number of benefits over traditional, fiat currencies, but have historically been difficult to use for many standard purchases. In many cases, a merchant may be unwilling or unable to receive payment via a blockchain currency, such as due to the lengthy processing times that many blockchain currencies require. In these instances, a consumer must be prepared to pay for purchases with both a standard payment method, such as using a fiat currency transaction account, as well as their blockchain wallet, be able to detect what payment methods are accepted by the merchant, and choose their payment method accordingly. This can be an inconvenient and time consuming process for consumers, as well as requiring consumers to carry multiple payment methods at any given time, which can be a security concern for many consumers.

At the same time, such setups may be inconvenient for merchants. Some merchants may be wary of accepting blockchain currency for payment due to the volatility of the value of such currency as well as difficulties that can be faced in converting the blockchain currency to a fiat currency. If a merchant is wary, but would like to accept blockchain currency as payment to serve their customers, it is often an all-or-nothing proposition, where the merchant can either accept payment by blockchain currency for all transactions or not. In addition, accepting blockchain currency as payment will also often require the merchant to modify their point of sale system to be able to communicate with a node in an associated blockchain network to ensure the processing of such transactions. These inconveniences may often dissuade a merchant from accepting blockchain currency as payment.

Thus, there is a need for a technological system that can facilitate acceptance of blockchain currency as payment for merchants with greater convenience and easier adoption, thus increasing the options available for consumers when paying for an electronic payment transaction. This is a technical challenge that needs a technical solution, which is provided below.

### SUMMARY

The present disclosure provides a description of systems and methods for hybrid payment authorization. An account number is provided to a consumer that is mapped to both a fiat transaction account and a blockchain wallet. This account number is given to merchants when paying for a payment transaction and submitted in an authorization request that is transmitted to a payment network as in a standard payment transaction. However, the back end processing server that receives the authorization request may, identifying that the number is configured for hybrid payment authorization, determine how to process the transaction based on the needs of the merchant involved. If the merchant is configured for receiving payment via blockchain currency, the processing server can identify the corresponding blockchain wallet of the consumer as well as an address for receipt by the merchant and process the blockchain transaction. If the merchant is not configured to receive blockchain currency or does otherwise not desire to receive blockchain currency for that transaction, the processing server can identify the corresponding fiat currency transaction account and process the transaction using standard techniques. The result is that a transaction can be paid for using fiat currency or blockchain currency using a single number provided by the consumer, thus increasing consumer convenience, and using the standard payment rails and payment infrastructure already available to merchants, thereby enabling merchants to start receiving payment via blockchain currency by doing no more than starting its own blockchain wallet.

A method for hybrid payment authorization includes: storing, in a merchant database of a processing server, a merchant profile, wherein the merchant profile includes at least a merchant identifier and a merchant public key of a merchant cryptographic key pair; receiving, by a receiver of the processing server, an authorization request for a payment transaction from an external entity, wherein the authorization request is formatted according to one or more standards and includes at least a plurality of data elements including at least a first data element configured to store an account number, a second data element configured to store the merchant identifier, and a third data element configured to store a transaction amount; generating, by a processing device of the processing server, a recipient blockchain address using the merchant public key; transmitting, by a transmitter of the processing server, at least the recipient blockchain address, a blockchain amount based on the transaction amount, and a sender digital signature to a node in a blockchain network; generating, by the processing device of the processing server, an authorization response for the payment transaction, wherein the authorization response is formatted according to the one or more standards and includes at least a plurality of data elements including a first data element configured to store a response code indicating approval or denial of the payment transaction; and transmitting, by the transmitter of the processing server, the generated authorization response to the external entity.

A system for hybrid payment authorization includes: a merchant database of a processing server configured to store a merchant profile, wherein the merchant profile includes at least a merchant identifier and a merchant public key of a merchant cryptographic key pair; a receiver of the processing server configured to receive an authorization request for a payment transaction from an external entity, wherein the authorization request is formatted according to one or more standards and includes at least a plurality of data elements including at least a first data element configured to store an account number, a second data element configured to store the merchant identifier, and a third data element configured to store a transaction amount; a processing device of the processing server configured to generate a recipient blockchain address using the merchant public key; and a transmitter of the processing server configured to transmit at least the recipient blockchain address, a blockchain amount based on the transaction amount, and a sender digital signature to a node in a blockchain network, wherein the processing device of the processing server is further configured to generate an authorization response for the payment transaction, wherein the authorization response is formatted according to the one or more standards and includes at least a plurality of data elements including a first data element configured to store a response code indicating approval or denial of the payment transaction, and the transmitter of the processing server is further configured to transmit the generated authorization response to the external entity.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for hybrid payment authorizations in accordance with exemplary embodiments.

FIG. 2 is a block diagram illustrating the processing server of the system of FIG. 1 for hybrid payment authorization in accordance with exemplary embodiments.

FIG. 3 is a flow diagram illustrating a process hybrid authorization of a payment transaction by the processing server of FIG. 2 in accordance with exemplary embodiments.

FIG. 4 is a flow chart illustrating an exemplary method for hybrid payment authorization in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express° , PayPal° , etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Hybrid Payment Authorization

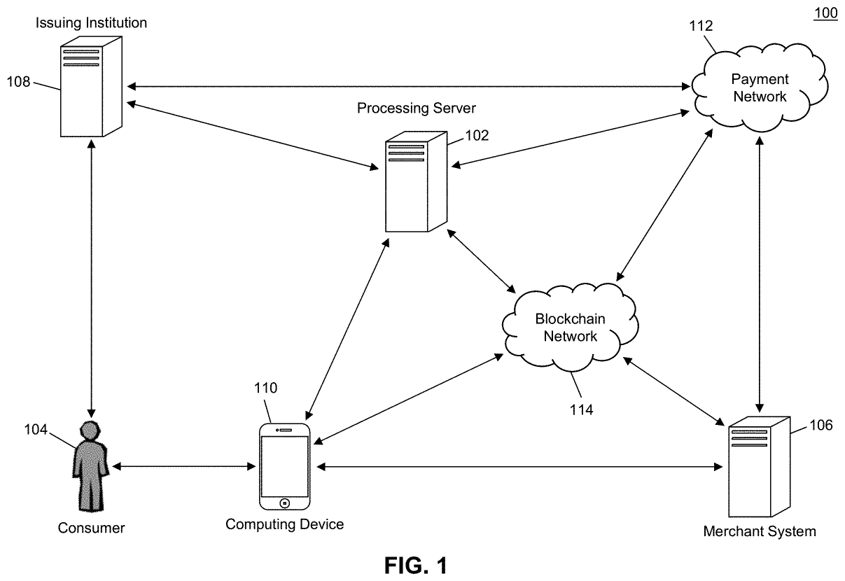

FIG. 1 illustrates a system 100 for the processing of electronic payment transactions using hybrid payment authorization, enabling a single account number to be used to fund a payment transaction by either fiat currency or blockchain currency depending on the needs of the merchant involved in the transaction.

The system 100 may include a processing server 102. The processing server 102, discussed in more detail below, may be configured to participate in the processing of electronic payment transactions including making determinations and facilitating processing of an electronic payment transaction as both a standard, fiat currency transaction as well as a blockchain transaction funded via a blockchain currency. In the system 100, a consumer 104 may want to purchase goods or services from a merchant system 106. The consumer 104 may have access to both a fiat currency transaction account used to fund payment transactions with a fait currency as well as a blockchain wallet used to fund payment transactions with a blockchain currency.

The fiat currency transaction account may be issued to the consumer 104 by an issuing institution 108. The issuing institution 108 may be a financial institution, such as an issuing bank, or other entity configured to issue transaction accounts that are suitable for funding an electronic payment transaction with a fiat currency. As part of the issuing of the transaction account, the issuing institution 108 may issue a payment instrument to the consumer 104, such as a physical payment card, virtual payment card, paper check, virtual check, etc. The consumer 104 may receive the payment instrument, which may be provided to a merchant system 106 to convey payment credentials associated with the transaction account fund a payment transaction with that transaction account.

The blockchain wallet may be associated with a blockchain network 114 that is used to transmit and receive blockchain currency in electronic payment transactions conducted via the blockchain network 114. A blockchain wallet may be an application program that is executed by a computing device 110 possessed by the consumer 104. A blockchain wallet may include a private key of a cryptographic key pair that is used to generate digital signatures that serve as authorization by the consumer 104 for a blockchain transaction, where the digital signature can be verified by the blockchain network 114 using the public key of the cryptographic key pair. In some cases, the term “blockchain wallet” may refer specifically to the private key. In some embodiments, such as discussed in more detail below, the processing server 102 may store the consumer's private key. In other embodiments, the private key may be stored on the computing device 110. The computing device 110 may be any type of device suitable for performing the functions discussed herein, such as a desktop computer, laptop computer, tablet computer, notebook computer, cellular phone, smart phone, smart watch, smart television, wearable computing device, implantable computing device, etc.

The blockchain network 114 may be comprised of a plurality of nodes. Each node may be a computing system that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 114 prior to the generation and addition of a new block to the blockchain in order for the change to be made permanent. Computational and communication limitations may make such a modification exceedingly difficult, if not impossible, thus rendering the blockchain immutable.

Each blockchain data value may correspond to a blockchain transaction. A blockchain transaction may consist of at least: a digital signature of the sender of currency (e.g., the consumer 104) that is generated using the sender's private key, a blockchain address of the recipient of currency (e.g., the merchant system 106) generated using the recipient's public key, and a blockchain currency amount that is transferred. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. In some cases, a blockchain transaction may also include the sender's public key, for use by any entity in validating the transaction. For the processing of a blockchain transaction, such data may be provided to a node in the blockchain network 114, either by the sender (e.g., via the computing device 110) or the recipient (e.g., by the merchant system 106). The node may verify the digital signature and the sender's access to the funds, and then include the blockchain transaction in a new block. The new block may be validated by other nodes in the blockchain network 114 before being added to the blockchain and distributed to all of the nodes in the blockchain network 114.

In a standard blockchain transaction, the consumer 104 may thus generate a digital signature using the computing device 110 using the private key thereof. The merchant system 106 may generate a blockchain address using its public key, which may be provided to the computing device 110. In some cases, the merchant system 106 may provide the computing device 110 with its public key, where the computing device 110 may generate the blockchain address. The computing device 110 may then submit the required information to a node in the blockchain network 114 for processing. In some instances, the node may return a blockchain transaction identifier to the computing device 110, which may be a value that is unique to that blockchain transaction for identification thereof. In such traditional transactions, the merchant system 106 is required to generate blockchain address or distribute its public key, and, in some cases, may be required to submit the transaction data directly to blockchain networks 114. In the system 100, the processing server 102 may perform these functions as part of the hybrid authorization of payment transactions for greater convenience and ease of adoption by merchant systems 106.

In the system 100, the consumer 104 may register with the processing server 102 for hybrid payment authorization. As part of the registration, the consumer 104 (e.g., or the financial institution 108 operating on behalf of the consumer 104) may provide the processing server 102 with the primary account number associated with the fiat currency transaction account issued to the consumer 104. The processing server 102 may also be provided with information associated with the consumer's blockchain wallet. In some embodiments, the processing server 102 may be provided with or given permission to generate the consumer's private key. In such embodiments, the processing server 102 may be configured to generate a digital signature on behalf of the consumer 104. In other embodiments, the processing server 102 may be given communication data of the computing device 110 used to contact the computing device 110 to request a digital signature when a blockchain transaction is to be processed. The processing server 102 may also be provided with, or given permission to generate, the public key of the consumer's cryptographic key pair. The public key may be provided to the nodes of the blockchain network 114 for use in validating the digital signature corresponding to the consumer's blockchain wallet.

Once the requisite data has been received, the processing server 102 may generate or otherwise identify (e.g., from a pool of available numbers) an account number that is uniquely associated with the consumer 104. The account number may be mapped in the processing server 102 to both the primary account number of the consumer's fiat currency transaction account as well as the consumer's blockchain wallet. The account number may be provided to the consumer 104 (e.g., via the computing device 110 or in a newly issued physical payment instrument).

When the consumer 104 wants to initiate a new payment transaction, the consumer 104 may provide the account number to the merchant system 106 using standards transmission methods. The merchant system 106 may receive the account number and include the account number in transaction data that is submitted to a payment network 112 for processing using standard methods. The transaction data may include the account number, a transaction amount, a merchant identification number, and any other data suitable for use in the processing of an electronic payment transaction, such as a transaction time, transaction date, geographic location, currency type, merchant category code, product data, reward data, offer data, loyalty data, acquirer data, issuer data, etc. In some embodiments, the transaction data may be submitted to the payment network 112 directly by the merchant system 106 using payment rails associated with the payment network 112. In other embodiments, the transaction data may be submitted via one or more intermediate entities, such as an acquiring institution or gateway processor.

The payment network 112 may receive the transaction data in the form of a transaction message. A transaction message may be a specially formatted data message that is formatted according to one or more standards governing the interchange of financial transaction messages, such as the International Organization of Standardization's ISO 8583 or ISO 20022 standards. The transaction message may include a plurality of data elements, where each data element is configured to store transaction data as indicated in the applicable standard(s), which may also be represented by one or more bitmaps stored in the transaction message. Each transaction message may also include a message type indicator indicative of a type of transaction message, used in the processing thereof. The transaction message received by the payment network 112 for the payment transaction may be formatted by the merchant system 106 or by an intermediate entity, such as an acquiring institution.

The transaction message may be an authorization request (e.g., as indicated by the message type indicator) where the data elements included therein may store the transaction data including at least the account number, transaction amount, and merchant identifier that is unique to the merchant involved in the payment transaction. In some embodiments, the processing server 102 may be a part of the payment network 112 and may assist in the processing of payment transactions thereby. In other embodiments, the processing server 102 may be external to the payment network 112 and may receive authorization requests form the payment network 112 for processing. In such instances, the payment network 112 may route all transaction messages to the processing server 102, where the processing server 102 may determine if hybrid payment authorization is to be performed, or may route only those transactions where hybrid payment authorization is to be performed to the processing server 102. In latter cases, such a determination may be made based on the account number included in the authorization request, where the account number may include an identification number that indicates hybrid payment authorization or otherwise results in routing of the authorization request to the processing server 102.

The processing server 102 may receive the authorization request and identify that the account number included therein is registered to a consumer 104 that is enrolled in hybrid payment authorization. The processing server 102 may also determine if the merchant system 106 is configured to receive payment for the payment transaction via blockchain currency. In some embodiments, the determination may be based on prior registration of the merchant system 106. In such embodiments, the merchant system 106 may provide the processing server 102 with its public key for its blockchain wallet. In some such cases, the merchant system 106 may also provide criteria to the processing server 102 for use in determining if an individual transaction can be funded by blockchain currency. For instance, the merchant system 106 may allow funding via blockchain currency for only those transactions having a transaction amount below a predetermined value. In other embodiments, a data element included in the authorization request may include a flag or other value used to indicate if processing as a blockchain currency is authorized by the merchant system 106. In some such embodiments, the merchant's public key may be stored in the data element or another data element in the authorization request. In some cases, the inclusion of the merchant system's public key may operate as authorization to process the transaction as a blockchain transaction.

If the merchant system 106 is not registered to receive funding via blockchain currency or has otherwise not authorized the transaction to be processed as a blockchain transaction, then the processing server 102 may identify the primary account number (PAN) associated with the consumer's fiat currency transaction account that is mapped to the account number included in the authorization request. The processing server 102 may swap the account number for the PAN and then forward the authorization request with the PAN to the issuing institution 108. The issuing institution 108 may perform standard processing thereof, which may include approving or declining the payment transaction via the return of an authorization response for the transaction that includes a data element configured to store a response code that indicates approval or denial of the payment transaction. In some cases, the authorization response may be returned directly to the payment network 112, which may continue to process the transaction using traditional methods. In other cases, the authorization response may be returned to the processing server 102, which may swap the PAN back out for the account number before forwarding the authorization response to the payment network 112 for any further processing. In these cases, the payment transaction may be funded via the consumer's fiat currency transaction account and the merchant may receive payment from the issuing institution 108 (e.g., through the merchant's acquirer) using standard methods.

If processing of the payment transaction as a blockchain transaction is authorized, then the processing server 102 may identify the consumer's blockchain wallet that is mapped to the account number included in the authorization request. In cases where the processing server 102 possesses the consumer's private key, the processing server 102 may generate the digital signature on behalf of the consumer 104. In other cases, the processing server 102 may request a digital signature from the computing device 110. In some instances, the computing device 110 may generate a digital signature that is transmitted to the processing server 102 when the payment transaction is initiated, in anticipation of processing as a blockchain transaction. The processing server 102 may also identify the merchant's blockchain address, either as included in the authorization request or generated by the processing server 102 using the merchant's public key (e.g., previously stored by the processing server 102 or included in the authorization request). The processing server 102 may then submit the blockchain transaction data to a node in the blockchain network 114 for processing.

In some cases, the processing server 102 may be required to convert the transaction amount included in the authorization request prior to processing. For instance, if the transaction amount is a fiat currency amount, then the amount may be converted into a blockchain currency amount by the processing server 102 if the payment transaction is to be processed as a blockchain transaction. Conversion of an amount between fiat currency and blockchain currency may be performed using standards methods, which may rely on exchange rates that are publicly available, set by the merchant system 106 and/or consumer 104, set by the processing server 102, set by the issuing institution 108, set by the payment network 112, or based on other considerations.

Once the blockchain transaction has been conducted, the processing server 102 may generate an authorization response for the payment transaction that includes a data element configured to store a response code indicating approval of the payment transaction. The authorization response may be transmitted to the payment network 112 (e.g., via payment rails associated therewith) where the payment network 112 may perform any additional processing. In some embodiments, the processing server 102 may wait until the blockchain network 114 provides (e.g., or the processing server 102 independently performs) confirmation of the blockchain transaction before returning the authorization response. In other embodiments, the processing server 102 may return the authorization response after submitting the blockchain transaction, before a confirmation is received. In some such embodiments, the processing server 102 may maintain an accounting of the blockchain currency available to the consumer's blockchain wallet, and may only return the authorization response prior to confirmation if the consumer's blockchain wallet has sufficient blockchain currency available to cover the blockchain transaction. In some instances, the accounting of blockchain currency available to the consumer's blockchain wallet may only be identifiable in cases where the processing server 102 possesses the private key for the consumer's blockchain wallet.

In some embodiments, if the consumer's blockchain wallet does not have sufficient blockchain currency available to cover the amount of the blockchain transaction (e.g., as identified by the processing server 102 or indicated by a node in the blockchain network 114 if processing of the blockchain transaction fails), the processing server 102 may attempt to process the payment transaction as a fiat currency transaction using the PAN mapped to the account number that corresponds to the consumer's fiat currency transaction account. The processing server 102 may likewise be configured to attempt to process a transaction as a blockchain transaction if processing as a fiat currency transaction fails. In some cases, such alternative processing may only be performed if authorized by the consumer 104 (e.g., during enrollment in the hybrid payment authorization).

In some embodiments, the processing server 102 may be configured to store data linking payment transactions processed as blockchain transactions with the underlying electronic payment transaction. In such embodiments, the processing server 102 may maintain a database that includes authorization requests or data included therein, such as a transaction identifier unique to the related electronic payment transaction such as may be identified in a corresponding data element in the authorization request, and blockchain transaction identifier for the blockchain transactions conducted as a result of the respective authorization request. Such a linkage may be suitable for use in auditing or the processing of refunds, exchanges, chargebacks, etc.

The methods and systems discussed herein allow for hybrid authorization of an electronic payment transaction as both a fiat currency transaction and blockchain transaction. The processing server 102 enables a consumer 104 to use a single account number for conducting both fiat currency transactions and blockchain transactions, resulting in greater consumer convenience. In addition, as the processing performed on the back end by the processing server 102 utilizes standard transaction message protocols and standards, the system 100 can be implemented with little to no modification to existing merchant systems (e.g., depending on how the merchant delivers its public key/blockchain address to the processing server 102) enabling merchants to begin to receive blockchain currency as payment without changing their point of sale systems and communication infrastructure. The result is significantly greater convenience and capabilities of both consumers 104 and merchant systems 106 without affecting the day-to-day actions of both parties. Processing Server

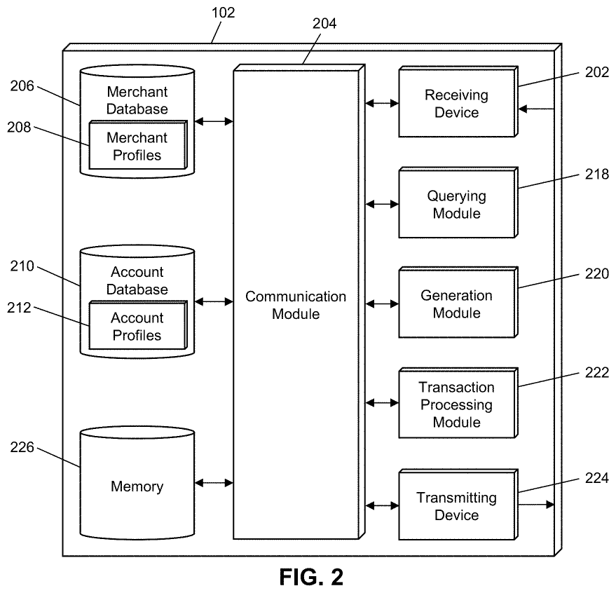

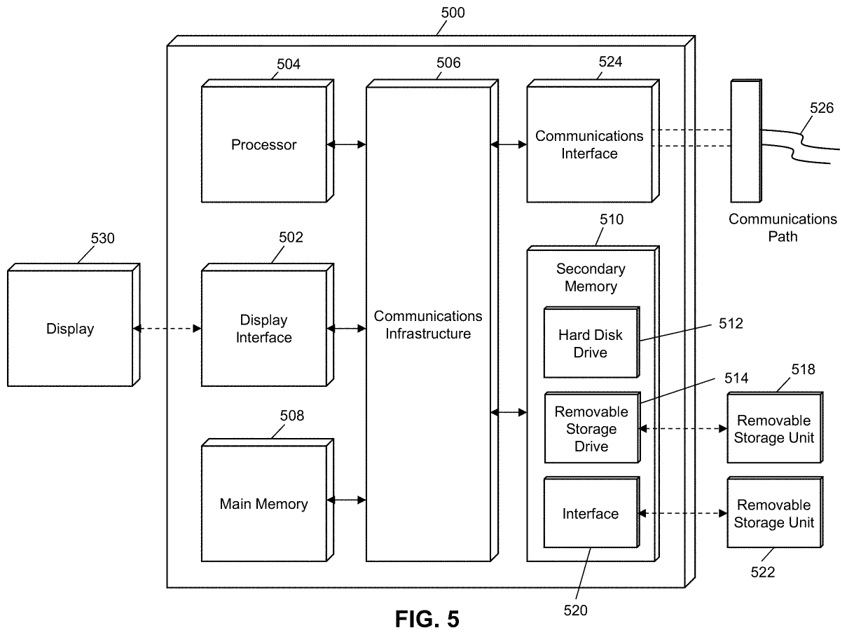

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchant system 106, issuing institutions 108, computing devices 110, payment networks 112, blockchain networks 114, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchant systems 106 that may be superimposed or otherwise encoded with a public key associated with the merchant system's blockchain wallet, for use in generating blockchain addresses. The receiving device 202 may also be configured to receive data signals electronically transmitted by issuing institutions 108 and/or computing devices 110, which may be superimposed or otherwise encoded with registration information for enrollment in hybrid payment authorization, such as may include a PAN for a fiat currency transaction account, proof of authorization for the consumer 104 of use thereof (e.g., authentication data), a blockchain wallet private key, communication data for a computing device 110, authorization to generate a cryptographic key pair for a blockchain wallet, or other data as discussed herein. The receiving device 202 may also be configured to receive data signals electronically transmitted by payment networks 112 and issuing institutions 108 that may be superimposed or otherwise encoded with transaction messages, including authorization requests and authorization responses, which may be transmitted using payment rails associated with a payment network 112. The receiving device 202 may also be configured to receive data signals electronically transmitted by nodes in a blockchain network 114, which may be superimposed or otherwise encoded with blockchain data values, new blocks, blockchain transaction confirmations including blockchain transaction identifiers, or other data as discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a merchant database 206. The merchant database 206 may be configured to store a plurality of merchant profiles 208 using a suitable data storage format and schema. The merchant database 206 may be a relational database that utilizes structured query language for the storage, identification, modifying, updating, accessing, etc. of structured data sets stored therein. Each merchant profile 208 may be a structured data set configured to store data related to a merchant system 106. Each merchant profile 208 may include data related to the registration of the merchant for receipt of funding for payment transactions via blockchain currency. Such data may include a public key of the related merchant's blockchain wallet, criteria for the funding of a payment transaction via blockchain currency, etc.

The processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a consumer 104 enrolled in hybrid payment authorization. An account profile 212 may include, for example, the account number issued to the consumer 104 for hybrid payment authorization, the PAN for the fiat currency transaction account mapped thereto, the private key for the consumer's blockchain wallet (e.g., if applicable), communication data for communicating with the computing device 110, or any other data as discussed herein, such as an available balance of blockchain currency, a supplied digital signature from the computing device 110, etc.

The processing server 102 may include a querying module 218. The querying module 218 may be configured to execute queries on databases to identify information. The querying module 218 may receive one or more data values or query strings, and may execute a query string based thereon on an indicated database, such as the merchant database 206, to identify information stored therein. The querying module 218 may then output the identified information to an appropriate engine or module of the processing server 102 as necessary. The querying module 218 may, for example, execute a query on the merchant database 206 to identify if a merchant involved in a payment transaction for which an authorization request has been receives is eligible for funding of a payment transaction via blockchain currency, such as by the existence of a merchant profile 208 associated with the involved merchant and data stored therein.

The processing server 102 may also include a generation module 220. The generation module 220 may be configured to generate data for use by the processing server 102 in performing the functions discussed herein. The generation module 220 may receive instructions as input, may generate data based on the instructions, and may output the generated data to one or more modules of the processing server 102. For example, the generation module 220 may be configured to generate notifications and other data messages for transmission to computing devices 110, such as prompts for digital signatures, registration data, an issued account number, etc., as well as for transmission to nodes in the blockchain network 114, such as for a new blockchain transaction to be processed. The generation module 220 may also be configured to generate digital signatures and blockchain addresses using private and public keys, respectively, using suitable algorithms. In some cases, the generation module 220 may also be configured to verify digital signatures using algorithms used in the generation of digital signatures, using a public key of a cryptographic key pair that includes the private key used to generate the digital signature.

The processing server 102 may also include a transaction processing module 222. The transaction processing module 222 may be configured to perform functions for the processing server 102 related to the processing of electronic payment transactions as discussed herein. Such functions may include, for example, the forwarding of authorization requests and authorization responses, the generation of authorization responses, the identification of issuing institutions 108, the swapping of an account number to/from a PAN in an authorization request or authorization response, the calculation of a fiat currency amount or blockchain currency amount via an exchange rate, etc.

The processing server 102 may also include a transmitting device 224. The transmitting device 224 may be configured to transmit data over one or more networks via one or more network protocols. In some instances, the transmitting device 224 may be configured to transmit data to issuing institutions 108, computing devices 110, payment networks 112, blockchain networks 114, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to issuing institutions 108 and payment networks 112 that are superimposed or otherwise encoded with transaction messages, including authorization requests and authorization responses, which may be transmitted via payment rails associated with the payment network 112. The transmitting device 224 may also be configured to electronically transmit data signals to computing devices 110, such as may be superimposed or otherwise encoded with account numbers for hybrid payment authorization enrollment, requests for digital signatures, notifications regarding hybrid payment authorizations, etc. The transmitting device 224 may also be configured to electronically transmit data signals to nodes in a blockchain network 114 that may be superimposed or otherwise encoded with data for use in a blockchain transaction, including at least a digital signature, recipient address, and blockchain currency amount.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, blockchain data, hashing algorithms for generating blocks, credentials for validation, usage rule templates, communication data for blockchain nodes, communication data for computing devices 110, routing information for transaction messages, transaction message formatting standards, currency exchange rate data and algorithms, etc. In some embodiments, the memory 226 may also be configured to store linkage data for linkages between electronic payment transactions and blockchain transactions associated therewith, where such linkages may include unique identifiers associated with each respective transaction. Process for Hybrid Payment Authorization

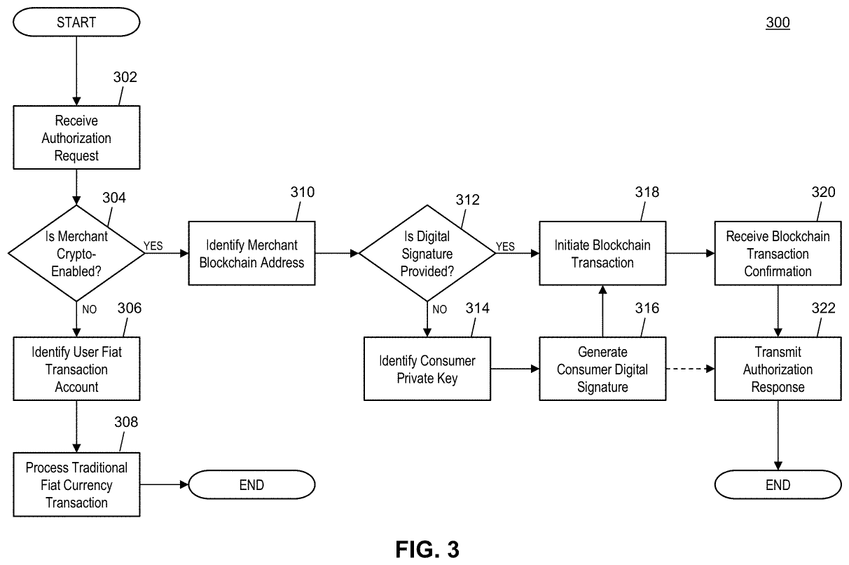

FIG. 3 illustrates an example process 300 for the hybrid payment authorization of an initiated electronic payment transaction as either a fiat currency transaction or blockchain transaction as executed by the processing server 102 of FIG. 2 in the system 100.

In step 302, the receiving device 202 of the processing server 102 may receive an authorization request for an electronic payment transaction from a payment network 112 using payment rails associated therewith. The authorization request may include a plurality of data elements including at least a first data element configured to store an account number, a second data element configured to store a transaction amount, and a third data element configured to store a merchant identifier. In step 304, the processing server 102 may determine if the merchant involved in the payment transaction (e.g., associated with the merchant identifier) is enabled to receive payment via a cryptographic blockchain currency. The determination may be based on the existence of a merchant profile 208 in the merchant database 206 and/or the inclusion of an indication in the merchant profile 208 for the related merchant (e.g., identifiable via an execution of a query on the merchant database 206 by the querying module 218 of the processing server 102 using the merchant identifier) that indicates that the related merchant is enabled to receive payment via blockchain currency. In some cases, the indication may be the storage of a public key for the merchant in the merchant profile 208. In some embodiments, the determination may be based on a flag or other data included in a predetermined data element included in the authorization request.

If the merchant is not enabled to receive payment via a blockchain currency, then, in step 306, the processing server 102 may identify the fiat currency transaction account used by the consumer 104 involved in the payment transaction. The querying module 218 of the processing server 102 may execute a query on the account database 210 of the processing server 102 to identify an account profile 212 related to the consumer 104 that includes the account number found in the authorization request. The account profile 212 may include a PAN associated with a fiat currency transaction account issued to or otherwise authorized for use by the consumer 104. In step 308, the transaction processing module 222 of the processing server 102 may swap the account number for the PAN in the authorization request, which may then be forwarded to the issuing institution 108 that issued the fiat currency transaction account by the transmitting device 224 using the payment rails associated with the payment network 112 or other suitable communication method. The issuing institution 108 may then process the payment transaction for funding via fiat currency using standard methods and systems.

If, in step 304, the processing server 102 determines that the merchant is enabled to receive funding for the initiated payment transaction via a blockchain currency, then, in step 310, the processing server 102 may determine a blockchain address to be used by the merchant in receiving the blockchain currency. In some embodiments, the address may be generated by the generation module 220 of the processing server 102 using the merchant's public key, which may be identified from the merchant's merchant profile 208 or included in a data element in the received authorization request. In other embodiments, the blockchain address may be stored in a data element in the received authorization request.

In step 312, the processing server 102 may determine if a digital signature has been provided by the consumer 104 for use in a blockchain transaction. In some cases, the determination may be based on the existence of a digital signature in the consumer's account profile 212 (e.g., previously provided by the consumer 104 using the computing device 110) or information indicating a digital signature can be made available (e.g., where the processing server 102 can request the digital signature from the computing device 110 during transaction processing). If no digital signature is available, then, in step 314, the querying module 218 of the processing server 102 may identify the private key associated with the consumer's blockchain wallet via querying the account database 210 to identify the account profile 212 related to the consumer 104 using the account number included in the authorization request. In step 316, the generation module 220 of the processing server 102 may generate a digital signature using the private key and a suitable signature generation algorithm.

Once the consumer's digital signature has been generated or otherwise received by the processing server 102, then, in step 318, the processing server 102 may initiate a blockchain transaction. Initiation of the blockchain transaction may include the transmission of at least the digital signature, merchant blockchain address, and a blockchain transaction amount (e.g., included in the authorization request or calculated by the transaction processing module 222 using the transaction amount from the authorization request and exchange rate data) to a node in the blockchain network 114 by the transmitting device 224 of the processing server 102 using a suitable communication network and method. In step 320, the receiving device 202 of the processing server 102 may receive a confirmation message from a node in the blockchain network 114 confirming processing of the blockchain transaction. In some cases, the confirmation message may include a blockchain transaction identifier. In some such cases, the blockchain transaction identifier may be stored in the memory 226 of the processing server 102 (e.g., via a query executed by the querying module 218 of the processing server 102) in a linkage with the authorization request or data included therein (e.g., a transaction identifier stored in a corresponding data element thereof).

In step 322, the transaction processing module 222 may generate an authorization response for the payment transaction that includes a data element configured to store a response code indicating approval of the payment transaction. In some cases, the authorization response may also include an indication, in a predetermined data element, that the payment transaction was processed as a blockchain transaction. In cases where a blockchain transaction identifier was received, the blockchain transaction identifier may serve as the indication or may be otherwise included in a corresponding data element in the authorization response. The transmitting device 224 of the processing server 102 may then electronically transmit the authorization response to the payment network 112 for additional routing and/or processing.

In some embodiments, the process 300 may proceed from step 316 directly to step 322, where steps 318 and 320 may be conducted concurrently with step 322 or after step 322. In such embodiments, the processing server 102 may identify if the consumer 104 has sufficient blockchain currency available with their blockchain wallet to cover payment of the payment transaction using blockchain currency, and may immediately transmit an authorization response approving the transaction prior to the blockchain transaction being processed. In such an embodiment, the payment transaction may be conducted immediately for convenience of the consumer 104 and merchant to avoid having to wait for delayed processing times of some blockchain networks 114.

If, in step 312, the processing server 102 determines that a digital signature has been provided by the consumer 104 for use in a blockchain transaction, then the process continues directly to step 318, as described above, without having to conduct steps 314 and 316.

### Exemplary Method for Hybrid Payment Authorization

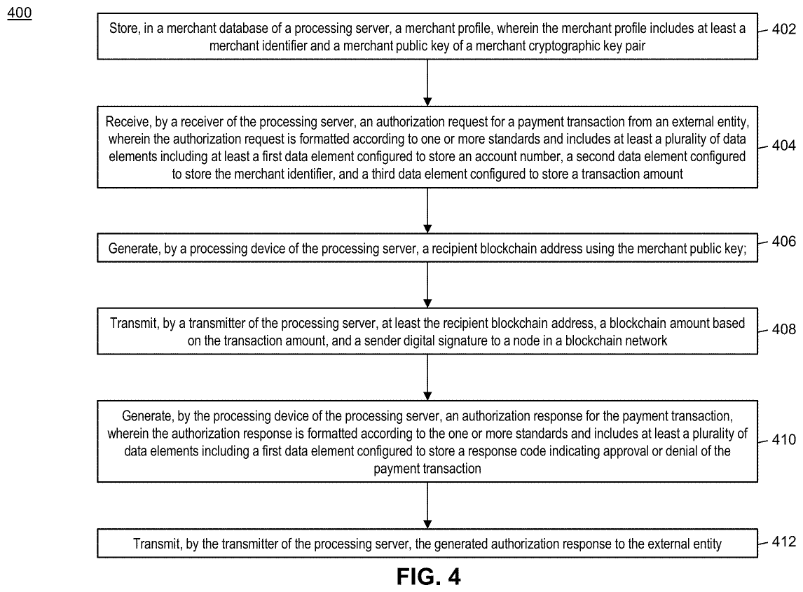

FIG. 4 illustrates a method 400 for the hybrid authorization of an electronic payment transaction submitted via a traditional authorization request funded through a blockchain transaction using a blockchain currency for registered merchants.

In step 402, a merchant profile (e.g., merchant profile 208) may be stored in a merchant database (e.g., the merchant database 206) of a processing server (e.g., the processing server 102), wherein the merchant profile includes at least a merchant identifier and a merchant public key of a merchant cryptographic key pair. In step 404, an authorization request for a payment transaction may be received by a receiver (e.g., the receiving device 202) of the processing server from an external entity (e.g., the payment network 112, issuing institution 108, merchant system 106, etc.), wherein the authorization request is formatted according to one or more standards and includes at least a plurality of data elements including at least a first data element configured to store an account number, a second data element configured to store the merchant identifier, and a third data element configured to store a transaction amount.

In step 406, a recipient blockchain address may be generated by a processing device of the processing server using the merchant public key. In step 408, at least the recipient blockchain address, a blockchain amount based on the transaction amount, and a sender digital signature may be transmitted by a transmitter (e.g., the transmitting device 224) of the processing server to a node in a blockchain network (e.g., the blockchain network 114).

In step 410, an authorization response for the payment transaction may be generated by the processing device of the processing server, wherein the authorization response is formatted according to the one or more standards and includes at least a plurality of data elements including a first data element configured to store a response code indicating approval or denial of the payment transaction. In step 412, the generated authorization response may be transmitted by the transmitter of the processing server to the external entity.

In one embodiment, the method 400 may further include receiving, by the receiver of the processing server, a confirmation message from the node in the blockchain network, wherein the confirmation message includes at least a blockchain transaction reference value. In a further embodiment, the plurality of data elements included in the authorization response may further include a second data element configured to store the blockchain transaction reference value. In another further embodiment, the method 400 may also include storing, in a memory (e.g., the memory 226) of the processing server, a linkage between the blockchain transaction reference value and the payment transaction. In an even further embodiment, the linkage may be between the blockchain transaction reference value and a transaction identifier included in a fourth data element included in the plurality of data elements included in the authorization request.

In some embodiments, the method 400 may further include: storing, in an account database (e.g., the account database 210) of the processing server, an account profile (e.g., account profile 212), wherein the account profile includes an sender private key of a sender cryptographic key pair and the account number; and generating, by the processing device of the processing server, the sender digital signature using the sender private key. In one embodiment, the method 400 may also include storing, in an account database of the processing server, an account profile, wherein the account profile includes a blockchain currency amount and the account number, wherein the blockchain currency amount is greater than the blockchain amount. In some embodiments, the method 400 may further include receiving, by the receiver of the processing server, the sender digital signature from an external computing device.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The external display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for hybrid payment authorization. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for hybrid payment authorization, comprising:
storing, in a merchant database of a processing server, a merchant profile, wherein the merchant profile includes at least a merchant identifier and a merchant public key of a merchant cryptographic key pair;
receiving, by a receiver of the processing server, an authorization request for a payment transaction from an external entity, wherein the authorization request is formatted according to one or more standards and includes at least a plurality of data elements including at least a first data element configured to store an account number, a second data element configured to store the merchant identifier, and a third data element configured to store a transaction amount;
generating, by a processing device of the processing server, a recipient blockchain address using the merchant public key;
transmitting, by a transmitter of the processing server, at least the recipient blockchain address, a blockchain amount based on the transaction amount, and a sender digital signature to a node in a blockchain network;
generating, by the processing device of the processing server, an authorization response for the payment transaction, wherein the authorization response is formatted according to the one or more standards and includes at least a plurality of data elements including a first data element configured to store a response code indicating approval or denial of the payment transaction; and
transmitting, by the transmitter of the processing server, the generated authorization response to the external entity.

2. The method of claim 1, further comprising:
receiving, by the receiver of the processing server, a confirmation message from the node in the blockchain network, wherein the confirmation message includes at least a blockchain transaction reference value.

3. The method of claim 2, wherein the plurality of data elements included in the authorization response further includes a second data element configured to store the blockchain transaction reference value.

4. The method of claim 2, further comprising:
storing, in a memory of the processing server, a linkage between the blockchain transaction reference value and the payment transaction.

5. The method of claim 4, wherein the linkage is between the blockchain transaction reference value and a transaction identifier included in a fourth data element included in the plurality of data elements included in the authorization request.

6. The method of claim 1, further comprising:
storing, in an account database of the processing server, an account profile, wherein the account profile includes an sender private key of a sender cryptographic key pair and the account number; and
generating, by the processing device of the processing server, the sender digital signature using the sender private key.

7. The method of claim 1, further comprising:
storing, in an account database of the processing server, an account profile, wherein the account profile includes a blockchain currency amount and the account number, wherein
the blockchain currency amount is greater than the blockchain amount.

8. The method of claim 1, further comprising:
receiving, by the receiver of the processing server, the sender digital signature from an external computing device.

9. A system for hybrid payment authorization, comprising:
a merchant database of a processing server configured to store a merchant profile, wherein the merchant profile includes at least a merchant identifier and a merchant public key of a merchant cryptographic key pair;
a receiver of the processing server configured to receive an authorization request for a payment transaction from an external entity, wherein the authorization request is formatted according to one or more standards and includes at least a plurality of data elements including at least a first data element configured to store an account number, a second data element configured to store the merchant identifier, and a third data element configured to store a transaction amount;
a processing device of the processing server configured to generate a recipient blockchain address using the merchant public key; and
a transmitter of the processing server configured to transmit at least the recipient blockchain address, a blockchain amount based on the transaction amount, and a sender digital signature to a node in a blockchain network, wherein
the processing device of the processing server is further configured to generate an authorization response for the payment transaction, wherein the authorization response is formatted according to the one or more standards and includes at least a plurality of data elements including a first data element configured to store a response code indicating approval or denial of the payment transaction, and
the transmitter of the processing server is further configured to transmit the generated authorization response to the external entity.

10. The system of claim 9, wherein the receiver of the processing server, a confirmation message from the node in the blockchain network, wherein the confirmation message includes at least a blockchain transaction reference value.

11. The system of claim 10, wherein the plurality of data elements included in the authorization response further includes a second data element configured to store the blockchain transaction reference value.

12. The system of claim 10, further comprising:
a memory of the processing server configured to store a linkage between the blockchain transaction reference value and the payment transaction.

13. The system of claim 12, wherein the linkage is between the blockchain transaction reference value and a transaction identifier included in a fourth data element included in the plurality of data elements included in the authorization request.

14. The system of claim 9, further comprising:
an account database of the processing server configured to store an account profile, wherein the account profile includes an sender private key of a sender cryptographic key pair and the account number, wherein
the processing device of the processing server is further configured to generate the sender digital signature using the sender private key.

15. The system of claim 9, further comprising:
an account database of the processing server configured to store an account profile, wherein the account profile includes a blockchain currency amount and the account number, wherein
the blockchain currency amount is greater than the blockchain amount.

16. The system of claim 9, wherein the receiver of the processing server is further configured to receive the sender digital signature from an external computing device.
